(19) United States
(12) Patent Application Publication
(10) Pub. No.: US 2023/0284635 A1
(43) Pub. Date: Sep. 14, 2023

(54) Flour Having Improved Organoleptic Properties

(71) Applicant: Frito-Lay North America, Inc., Plano, TX (US)

(72) Inventors: Jin-E Shin, Hoffman Estates, IL (US); Antony Alex Tipton, McKinney, TX (US); Chen Chun Shao, Vernon Hills, IL (US); Prabhakar Kasturi, Barrington, IL (US); Todd A. Rakofsky, Crystal Lake, IL (US); Zhanfeng Xu, Hoffman Estates, IL (US)

(21) Appl. No.: 17/692,678

(22) Filed: Mar. 11, 2022

(51) Int. Cl. A21D 8/04; A21D 13/045

(52) U.S. Cl. CPC A21D 8/04; A21D 13/045

(57) ABSTRACT

A fermented flour having an improved mouthfeel and taste includes a reduced concentration of off-flavor compounds. Methods of reducing the off-flavored compounds concentration in a flour include fermenting the flour under solid state fermenting conditions.

The present disclosure relates generally to methods of producing a flour with improved organoleptic properties. More specifically, the present disclosure relates to methods of fermentation to reduce the presence of one or more flavor compounds intrinsically present in a flour, particularly to reduce off-flavor compounds.

### BACKGROUND

Flour has been, and continues to be, a staple in the diet of modern humans. Due to the rise of heart disease, obesity, and cholesterol, health-conscious consumers are making an effort to reassess their diets and replace high caloric foods with healthier alternatives. Specifically, consumers look to incorporate foods that contain higher amounts of protein, fiber, and other nutrients. However, these products may exhibit undesirable mouthfeel characteristics or taste. For example, such products may be too gritty or may result in a thick coating on the mouth during consumption. Additionally, such food products tend to have off-flavors as a result of volatile compounds naturally present in the food source or generated during processing. As such, there is a need for a flour having increased health benefits that provides a desirable consumption experience for the consumer.

### SUMMARY

Despite the benefits, a person is less likely to consume a healthy food product that contains off-flavor compounds. Off-flavor compounds formed by lipid oxidation can give off aromatic notes such as “beany,” “rancid,” or “pungent green.” By controlling the presence and/or concentration of flavor compounds in a flour, the resulting dough and subsequently produced food product may have improved organoleptic properties. In some embodiments, the disclosed methods may eliminate or reduce the concentration of off-flavor compounds found in the flour without altering the percentage of fat, protein, and total sugars as compared to the percentage of fat, protein, and total sugars in a flour that has not been fermented according to the disclosed method. In some embodiments, the amount of protein in the flour after the fermentation process is at least 90% of the amount of protein before fermentation. What's more, dough and food products produced using the disclosed fermented flours tended to have a softer texture compared to a non-fermented flour (a control sample).

Methods to control the concentration of flavor compounds (i.e., off-flavor compounds and flavor-enhancing compounds) in a flour are disclosed. In one aspect, the method may include forming a mixture containing a liquid and about 30 wt. % to about 65 wt. % flour. The flour may be formed from a grain, a pulse, a seed, or mixture of a grain, pulse, and seed. In some instances, the flour may be formed from chickpeas. Prior to forming the mixture, the flour may have undergone pre-processing, such as, extrusion or pre-gelling a percentage of the flour's starch.

The mixture may then be seeded with at least one microorganism to form a seeded mixture and allowed to ferment to form a fermented material. In some embodiments, the seeded mixture ferments at a temperature ranging between about 65° F. to about 110° F. In some embodiments, the seeded mixture ferments for about 2.5 hours to about 17 hours.

During fermentation, the concentration of one or more off-flavor compounds may be reduced and, in some embodiments, the perception of one or more flavor-enhancing compounds is increased. In other words, the fermented material has a concentration of one or more flavor compounds that is lower than the concentration of the same one or more flavor compounds in the non-fermented flour. Without being limited by theory, it is thought that when the off-flavor compounds are reduced, the taste of the fermented flour is muted or dulled. For example, the fermented material may have a lower concentration of one or more lipid oxidation products such as the off-flavor compound hexanal. This allows the fermented flour to be incorporated into food products without having to compensate for off-flavors. In some aspects, the reduction of the concentration of off-flavor compounds may allow the flavor-enhancing compounds to impart an overall pleasant taste to the fermented flour.

In some embodiments, the fermented material has a moisture content ranging from about 30 wt. % to about 70 wt. %. The fermented material may be pasteurized and/or dried after fermentation. A fermented flour results from drying the fermented material to a moisture content of about 0.5 wt. % to about 8 wt. %.

The disclosed fermented flour may be combined with other ingredients to form a dough that may be processed according to known methods to produce food products (e.g., bread or crackers). In some aspects, the result of the disclosed methods is a flour having reduced off-flavor compounds that may be used and/or sold as a stand-alone staple item. The described methods may be modified as described depending on the desired attributes of the fermented flour. Food products formed from the fermented flour benefit from the modified texture and flavor profile.

Unless otherwise specifically noted, all recited percentages refer to a percent by weight.

### BRIEF DESCRIPTION OF THE DRAWINGS

The following description accompanies the drawings, all given by way of non-limiting examples that may be useful to understand how the described process and system may be embodied. Reference is made to Sample No. 1, 2, 3, 4, or 5. The contents of each Sample are provided in Table 1 below.

FIG. 1 is an exemplary flowsheet of processes to form flour having a reduced concentration of one or more flavor compounds according to disclosed embodiments.

FIG. 2 is a graph comparing the flavor compound profiles of non-fermented chickpea flour with the same flavor compound profiles of several fermented chickpea flour samples made according to the disclosed methods.

FIG. 3 is a graph comparing the concentration of pentanal, hexanal, and heptanal in non-fermented chickpea flour and in several fermented chickpea flour samples made according to the disclosed methods.

FIG. 4 is a graph comparing the concentration of benzaldehyde, trans-2-heptenal, and 1-octen-3-ol in non-fermented chickpea flour and in several fermented chickpea flour samples made according to the disclosed methods.

FIG. 5 is a graph comparing the concentration of trans,trans-2,4-heptadienal, 2-pentylfuran, and octanal in non-fermented chickpea flour and in several fermented chickpea flour samples made according to the disclosed methods.

FIG. 6 is a graph comparing the concentration of trans-2-octenal, trans,trans-2,4-octadienal, and nonanal in non-fermented chickpea flour and in several fermented chickpea flour samples made according to the disclosed methods.

FIG. 7 is a graph comparing the concentration of trans,cis-2,6-nonadienal, trans-2-nonenal, and decanal in non-fermented chickpea flour and in several fermented chickpea flour samples made according to the disclosed methods.

FIG. 8 is a graph comparing the concentration of trans,trans-2,4-nonadienal, trans-2-decenal, and trans,trans-2,4-decadienal in non-fermented chickpea flour and in several fermented chickpea flour samples made according to the disclosed methods.

FIG. 9 is a graph comparing strecker aldehyde concentrations in non-fermented chickpea flour and in several fermented chickpea flour samples made according to the disclosed methods.

FIG. 10 is a graph comparing the concentration of pyrazine in non-fermented chickpea flour and in several fermented chickpea flour samples made according to the disclosed methods.

FIG. 11 is a graph comparing the concentration of esters in non-fermented chickpea flour and in several fermented chickpea flour samples made according to the disclosed methods.

FIG. 12 is a graph comparing the concentration of alcohols in non-fermented chickpea flour and in several fermented chickpea flour samples made according to the disclosed methods.

FIG. 13 is a graph comparing the concentration of ketones in non-fermented chickpea flour and in several fermented chickpea flour samples made according to the disclosed methods.

FIG. 14 is a graph comparing the concentration of various compounds in non-fermented Sample No. 1 to the concentration of the same compounds in fermented Sample No. 2, measured at 4 hours and 17 hours after the initiation of fermentation.

FIG. 15 is a graph comparing the concentration of various compounds in non-fermented Sample No. 1 to the same compounds in fermented Sample No. 3, measured at 4 hours and 17 hours after the initiation of fermentation.

FIG. 16 is a graph comparing the concentration of various compounds in non-fermented Sample No. 1 to the same compounds in fermented Sample No. 4, measured at 4 hours and 17 hours after the initiation of fermentation.

FIG. 17 is a graph comparing the concentration of various compounds in non-fermented Sample No. 1 to the same compounds in fermented Sample No. 5, measured at 4 hours and 17 hours after the initiation of fermentation.

FIG. 18 is a graph showing the concentration of flavor compounds in chickpea crackers formed from fermented flours (Sample Nos. 2, 3, 4, or 5) and formed from a non-fermented flour (Sample No. 1).

FIG. 19 is a graph showing the force (grams force) required to compress the various dough samples.

### DETAILED DESCRIPTION

A fermented flour formed according to the following methods exhibits a pleasing taste, mouthfeel, and functionality (e.g., nutrition). Specifically, a starting flour is fermented using the described methods to control the presence and concentration of various flavor compounds. The phrase “flavor compounds” includes off-flavor compounds and flavor-enhancing compounds. Many flavor compounds are naturally present or form during common industrial processing. By reducing the concentration of off-flavor compounds, flavor-enhancing compounds may become more dominant in the flavor profile. Additionally, the disclosed fermentation methods have the advantage of producing flavor-enhancing compounds where none existed before. As a result, the fermented flour may be incorporated into a dough to prepare food products that have reduced concentrations of off-flavors.

With respect to mouthfeel, in some embodiments, the disclosed methods may impart a softer texture profile. For example, a dough prepared using a fermented-version of the starting flour may have a softer texture profile compared to a dough prepared using the non-fermented-version of the starting flour. This texture property was observed in food products formed from the fermented dough. Advantageously, this softened texture makes it possible to prepare a food product containing higher percentages of healthy flour alternatives with improved mouthfeel.

### Methods of Fermentation

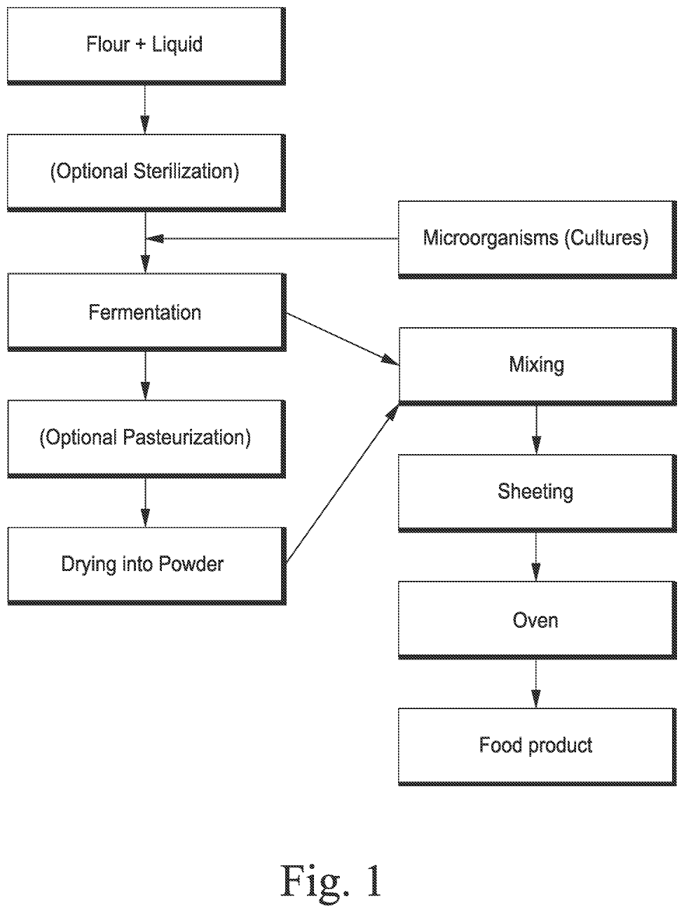

Referring to FIG. 1, an illustrative method for forming a flour having a reduced concentration of one or more flavor compounds is shown. According to one aspect, a flour may be combined with a liquid, generally water, to form a mixture. The mixture may optionally be sterilized and thereafter, the mixture may be seeded with at least one type of microorganism to form a seeded mixture. Once seeded, the seeded mixture is allowed to ferment for an amount of time and at a temperature to form a fermented material. Upon reaching the desired level of fermentation, the fermentation process may be stopped by any suitable means such as by increasing the temperature to deactivate the microorganisms. The fermented material may optionally be pasteurized and/or subsequently dried to a powder having a desired moisture content to produce a fermented flour. In some embodiments, the fermented flour and/or fermented material may be directly mixed with other ingredients to form a dough. The dough containing the fermented material and/or fermented flour may be processed using known methods to produce a food product.

The flour or “starting flour” combined with a liquid to form the mixture, may be prepared from seeds, roots, grains, pulses such as legumes, and other plant components, such as bark, or a combination of two or more of these. The starting flour is not necessarily limited to a specific source or type. As an example, the pulses may be selected from dry beans, lentils, faba beans, dry peas, chickpeas, cowpeas, Bambara beans, pigeon peas, lupins, vetches, peanuts, soybean, pinto beans, navy beans, kidney beans, black turtle beans, Dutch brown beans, pink beans, cranberry beans, small red beans, lima azuki, mung and black gram, black-eyed peas, or a combination of two or more of these. For example, the grains may be selected from wheat, oats, barley, spelt, rice, corn, barley, sorghum, rye, millet, teff, triticale, amaranth, kaniwa, cockscomb, green groat, buckwheat, quinoa, or a combination of two or more of these. Additionally, the starting flour may be formed from a nut or seed selected from an acorn, almond, cattail seeds, chestnut, coconuts, crabgrass seeds, curly dock, flint/dent corn, mesquite pods, parsnip, plantain, purslane, spelt, soy, or a combination of two or more of these.

Prior to forming the mixture, the starting flour may be processed to modify the starch present in the flour. For example, the starch may be gelatinized using known methods such as heat with high moisture conditions. Alternatively, the starch may be dextrinized by known methods such as grinding and heating in low moisture conditions. In some embodiments, the starting flour may be extruded prior to forming the mixture.

The amount of starting flour present in the mixture may range from about 10 wt. % to about 90 wt. %, about 15 wt. % to about 85 wt. %, about 20 wt. % to about 80 wt. %, about 25 wt. % to about 75 wt. %, about 30 wt. % to about 70 wt. %, about 40 wt. % to about 60 wt. %, or about 45 wt. % to about 55 wt. %. The amount of starting flour present in the mixture may be about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. %. In some embodiments, the amount of flour present in the mixture is about 35 wt. % to about 55 wt. %.

The liquid used in the mixture may include water, juice, or milk (including reconstituted milk). The water may be filtered, deionized, or autoclaved water. The amount of liquid present in the mixture may range from about 5 wt. % to about 90 wt. %. The liquid may be present in the mixture in a range of about 5 wt. % to about 85 wt. %, about 10 wt. % to about 80 wt. %, about 25 wt. % to about 75 wt. % about 30 wt. % to about 70 wt. %, about 40 wt. % to about 60 wt. %, or about 45 wt. % to about 55 wt. %. In some embodiments, the amount of liquid present in the mixture is about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. %.

The mixture may include additional components such as sugar, minerals, or micronutrients. A sugar may include glucose, fructose, sucrose, and/or any other simple or complex sugars used in the production of food and beverage products. The sugar may also be a combination of any simple and/or complex sugars or carbohydrates. The mixture may contain additional components in amounts ranging from about 0.001 wt. % to about 40 wt. %, about 0.01 wt. % to about 30 wt. %, about 0.1 wt. % to about 20 wt. %, or about 1 wt. % to about 10 wt. %. The additional components may be present in an amount of about 0.001 wt. %, about 0.01 wt. %, about 0.1 wt. %, about 1 wt. %, about 5 wt. %, about 10 wt. %, about 15 wt. %, about 20 wt. %, about 25 wt. %, about 30 wt. %, about 35 wt. %, or about 40 wt. %.

After combining the starting flour, liquid, and additional components, if any, to form the mixture, the mixture may optionally be sterilized. The terms “sterilized,” “sterilization,” “sanitization,” “sanitizing,” and/or “sterilizing” refer to the process of killing and/or eliminating microorganisms that are detrimental to the safe and long-term storage of the mixture of the present disclosure. In the present disclosure, the terms “sterilized,” “sterilization,” “sanitization,” “sanitizing,” and/or “sterilizing” often refer to the treatment of a composition via irradiation, such as with ultraviolet (UV) light treatment, or via a process where compositions may be heat treated, to a temperature ranging from about 85° C. to about 110° C. with or without pressure, to eliminate or substantially reduce viable microbial pathogens, such as bacteria, fungi, viruses, and/or yeast. The mixture may be continuously stirred to uniformly heat and/or expose the mixture to the heat.

Once the mixture is formed, and optionally sterilized, the mixture may be seeded with one or more microorganisms capable of fermenting the mixture (primarily the starting flour) in a solid state fermentation process. Suitable microorganisms capable of fermenting the mixture in a solid state fermentation process may be selected from yeast, bacterium, or fungi. The microorganism may be thermophilic. In some embodiments, the microorganism is selected from Lactobacillus lactis, Streptococcus thermophilus, Lactobacillus delbrueckii, Lactobacillus acidophilus, Lactobacillus paracasei, Lactobacillus casei, Bifidobacterium lactis, Bifidobacterium animalis, Lactococcus lactis, Lactobacillus plantarum, Lactobacillus sakei, Lueconostoc mesenteroids, Lactobacillus rhamnosus, Pediococcus, Kluyveromyces marxianus, or a combination of two or more of these. If a Lactobacillus delbrueckiiis selected, it may be the subspecies Bulgaricus or Lactis. If a Kluyveromyces marxianus is selected, it may be the subspecies Fragilis. If a Lactococcus lactis is selected, it may the subspecies Lactis.

The mixture may be seeded with one to ten different strains of microorganisms. The amount of microorganism employed may depend on the flour type and the desired end product. In some embodiments, the mixture may be seeded with about 1 million CFUs to about 500 billion CFUs per 100 g of mixture.

In the present disclosure, the term “fermentation” generally refers to the metabolic process where carbohydrates, such as sugars, are metabolized by “live yeasts” and/or “live bacteria” and converted into acids, gases, and/or alcohols. For example, fermentation of sugar by “live yeasts” often results in the formation of alcohols, such as ethanol. “Live bacteria,” excluding heterofermentative “live bacteria,” are generally unable to metabolize sugars in a way that converts the sugars to ethanol. However, homofermentative “live bacteria” are able to convert sugar to acid, rather than alcohol. Illustrative acids produced by the homofermentative conversion of sugar by “live bacteria” include, but are not limited to lactic acid, acetic acid, formic acid, gluconic acid, citric acid, succinic acid, and others. Accordingly, one or more of the microorganisms seeded in the mixture may be a homofermentative “live bacteria.” In some embodiments, the process does not include heterofermentative bacteria.

Once seeded with the at least one microorganism to form a seeded mixture, fermentation can begin. Solid state fermentation may be used to ferment the flour. The “solid” refers to the increased amount of solid content and reduced amount of free water present during fermentation. The seeded mixture serves as the substrate for the one or more microorganisms. The seeded mixture may be aerated during fermentation by forced air, shaking, mixing, or any such combination depending on the equipment employed to perform the solid state fermentation. In some embodiments, the solid state fermentation occurs in a static bioreactor.

While traditional liquid fermentation requires submerging a substrate into a liquid, solid state fermentation requires less liquid. The moisture content of the seeded mixture during and after fermentation may be about the same as the amount of liquid added to form the mixture. In some embodiments, the mixture and/or fermented material may have a moisture content of at least about 30 wt. % and may, in some instances, have a moisture content of up to about 65 wt. %. In some embodiments, the fermented flour may have a moisture content of between about 30 wt. % to about 65 wt. %, about 30 wt. % to about 60 wt. %, about 30 wt. % to about 55 wt. %, about 30 wt. % to about 50 wt. %, about 30 wt. % to about 45 wt. %, about 30 wt. % to about 40 wt. %, about 30 wt. % to about 35 wt. %, about 35 wt. % to about 65 wt. %, about 35 wt. % to about 60 wt. %, about 35 wt. % to about 55 wt. %, about 35 wt. % to about 50 wt. %, about 35 wt. % to about 45 wt. %, about 35 wt. % to about 40 wt. %, about 40 wt. % to about 65 wt. %, about 40 wt. % to about 60 wt. %, about 40 wt. % to about 55 wt. %, about 40 wt. % to about 50 wt. %, about 40 wt. % to about 45 wt. %, about 45 wt. % to about 65 wt. %, about 45 wt. % to about 60 wt. %, about 45 wt. % to about 55 wt. %, or about 45 wt. % to about 50 wt. %. In some embodiments, the mixture and/or fermented material may have a moisture content of about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, or about 65 wt. %..

Fermentation may occur over a time period between about 2.5 hours to about 17 hours, about 2.5 hours to about 15 hours, about 2.5 hours to about 12 hours, about 2.5 hours to about 10 hours, about 3 hours to about 13 hours, about 3 hours to about 9 hours, about 3 hours to about 6 hour, about 3 hours to about 5 hours, about 3 hours to about 4 hours, about 4 hours to about 8 hours, about 4 hours to about 6 hours, or about 4 hours to about 5 hours.

During fermentation, the mixture may undergo acidification. In some embodiments, it is contemplated that the fermentation occurs for a time period sufficient to achieve a pH from about 3.0 to about 7.0, about 3.0 to about 6.5, about 3.0 to about 6.0, about 3.0 to about 5.5, about 3.0 to about 5.0, about 3.0 to about 4.5, about 3.5 to about 5.5, or about 3.5 to 5. In some instances, fermentation occurs for a time period sufficient to achieve a pH of about 3.0, about 3.5, about 4.0, about 4.5, about 5.0, about 5.5, or about 6.0.

During fermentation, the temperature may be at least about 65° F. (or about room temperature, also referred to as ambient temperature). The temperature may be about 120° F. or less. In some aspects, the temperature ranges between about 65° F. to about 120° F., about 77° F. to about 120° F., about 85° F. to about 115° F., or about 90° F. to about 110° F. The temperature may be adjusted depending on the type of one or more microorganisms seeded on the substrate. In some embodiments, no heat is added during fermentation allowing the process to occur at room temperature.

Once the desired amount of fermentation has occurred, the process may be stopped using known methods to deactivate the one or more microorganisms. An indicator that the fermented material has reached the end point may be determined by time, pH, the concentration of one or more flavor compounds, a reduction in concentration of one or more flavor compounds, an increase in concentration of one or more flavor compounds, or a combination of two or more of these indicators.

After fermentation, the fermented material may be optionally pasteurized and/or dried into a powder to form a fermented flour. Alternatively, the fermented material may be directly combined with other ingredients to produce food products, as illustrated in FIG. 1. For example, the fermented material may be combined with other ingredients, such as other flours, including but not limited to, potato flour, rice flour, corn flour, or mixtures thereof, formed into a sheet, and baked to form a cracker or biscuit. The ratio of dry ingredients to liquid ingredients can be discerned by a person having ordinary skill in the art.

Subsequent to fermentation, the fermented material may optionally be pasteurized. The term “pasteurization” or “pasteurizing” refers to a process where a composition (e.g., the fermented material of the present disclosure) is heat treated i to stop the fermentation process or to eliminate and/or kill pathogenic microorganisms and other undesired organisms, including but not limited to bacteria, fungi, viruses, and/or yeast. Heat may be directly and/or indirectly applied to the composition via any heat source means sufficient to kill pathogens, including but not limited to a heater, a heat exchanger (e.g., a plate heat exchanger), hot water, steam, etc. Typically, pasteurizing a composition involves treating with heat such that the composition is sterilized and/or sanitized by logarithmically destroying and/or inactivating microbial organisms that may contribute to spoilage and/or degradation. Therefore, pasteurizing a composition also comprises a thermal inactivation process that often helps to increase the shelf-life and/or storage-life of the treated composition.

The pasteurization process, with or without pressure, is typically conducted at a minimum temperature of about 93° C. (i.e., about 199° F.). For example, the fermented flour may be pasteurized at a temperature ranging from about 93° C. to about 135° C., from about 93° C. to about 125° C., from about 93° C. to about 115° C., from about 93° C. to about 105° C., from about 93° C. to about 100° C., from about 93° C. to about 99° C., from about 93° C. to about 98° C., from about 93° C. to about 97° C., from about 93° C. to about 96° C., from about 93° C. to about 95° C., from about 93.4° C. to about 94.4° C., and finally at or about 94.5° C. Alternatively, the pasteurization process may include the application of isostatic pressure using a cold pasteurization technique called high pressure processing.

The fermented material may be dried into a powder with a moisture content ranging from about 0.1 wt. % to about 10 wt. % to produce the fermented flour. Once formed, the fermented flour may be packaged and sold as a staple item. In some embodiments, the fermented flour is combined with other ingredients to form food products, as shown in FIG. 1. The resulting fermented flour may have an altered texture profile compared to the starting flour that allows for the incorporation of significant amounts of the fermented flour into a dough. Interestingly, in some embodiments, the described methods altered the texture profile of the fermented flour making it possible to combine greater amounts of fermented flour into a dough, compared to the starting flour, without clogging/jamming the industrial equipment. See the Fermented Plant-Based Flour Section for more details. When forming a dough, the ratio of fermented flour to non-fermented flour may be about 1:1, about 2:1, about 3:1, about 4:1, about 5:1, about 6:1, about 7:1, or about 8:1.

According to other embodiments, a starting chickpea flour is combined with a liquid to form a mixture. The starch within the starting chickpea flour may contain between about 1 wt. % to about 99 wt. % gelatinized starch. In some embodiments, the starting chickpea flour may contain between 1 wt. % to 99 wt. % dextrinized starch. The liquid may be water. The mixture may contain about 10 wt. %, about 40 wt. %, or about 70 wt. % starting chickpea flour. In some embodiments, the mixture contains about 35 wt. % to about 55 wt. % starting chickpea flour. Additional components may be included in the mixture including sugar, minerals, or micronutrients. The mixture may optionally be sterilized before seeding with one or more microorganisms. The one or more microorganisms may be selected from Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, Lactobacillus plantarum, Lactococcus lactis ssp. lactis, Kluyveromyces marxianus, or a combination of two or more of these microorganisms. The seeded mixture may ferment in a static bioreactor for about 2 hours to about 6 hours at a temperature of about 85° F. to about 115° F. A fermented chickpea material results from the described solid state fermentation process. The fermented material may be combined with other ingredients to form a dough and eventual food product. Alternatively, the fermented material may be dried to form a fermented flour.

The following is an exemplary embodiment of the disclosed methods and fermented flours formed using the disclosed methods.

In one aspect, about 35 wt. % to about 45 wt. % of a starting chickpea flour is combined with about 65 wt. % to 55 wt. % water to form a mixture. The starting chickpea flour may contain pre-gelled starch. In some embodiments, the starting chickpea flour has been extruded. The mixture may optionally be sterilized and cooled. Next, the mixture (whether sterilized or not) is seeded with an amount of one or more microorganisms to provide about 1 million CFU per 100 grams of mixture to about 500 billion CFU per 100 grams of mixture. The one or more microorganisms may be selected from Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, Lactobacillus plantarum, Lactococcus lactis ssp. lactis, Kluyveromyces marxianus, or a combination of two or more of these microorganisms.

During fermentation, heat may be applied to the seeded mixture. In some embodiments, heat is not applied to the seeded mixture. The seeded mixture may be allowed to ferment for about 2.5 hours to about 5 hours to form a fermented material. To stop fermentation, the fermented material may be exposed to a heat and/or pressure capable of eliminating the activity of the one or more microorganisms.

After fermentation, the fermented material may be directly combined with other ingredients to prepare a dough. The dough may include additional liquid and/or dry ingredients. Alternatively, the fermented material may be dried to produce a fermented flour, which may then be combined with other ingredients to form a dough.

In some aspects, because the concentration of one or more off-flavor compounds has been reduced and/or one or more flavor-enhancing compounds may be produced, the fermented material or fermented flour may be present in the dough at greater amounts as compared to the starting flour, without detriment to the overall flavor. In some aspects, one or more flavor compounds are reduced and/or produced by the disclosed methods, which may impart a better taste to a subsequently prepared food product. Accordingly, the improved tasting fermented material/or fermented flour (prepared according to the described methods) may be present in the dough at a greater amount as compared to the starting flour.

For example, the amount of fermented chickpea flour incorporated into a dough may be between about 50 wt. % to about 90 wt. %, about 55 wt. % to about 85 wt. %, about 60 wt. % to about 80 wt. %, about 65 wt. % to about 75 wt. %, or about 70 wt. % to about 80 wt. % of the total weight of dry ingredients.

### Fermented Plant-Based Flour

The following describes a fermented flour having an altered concentration of flavor compounds compared to the starting material (i.e., the starting flour). The flavor compounds include off-flavor compounds and flavor-enhancing compounds. In some embodiments, the fermented flours have a reduced concentration of off-flavor compounds and/or enhanced flavor and odor profiles. As previously described, the starting flour may be provided from seeds, roots, grains, pulses (e.g., chickpeas), other plant components, such as bark, or a combination thereof. The amount of flavor compounds before and after fermentation may be described using the following units: ng/mL, ng/g, or ppm. It is known that 1 ppm=1000 ng/mL and 1 ppm=1000 ng/g. The amount of flavor compounds present in the flour are expressed in both units and a person having ordinary skill in the art would readily understand the conversion.

The fermented flour may have a moisture content of at least about 0.5 wt. % and may, in some instances, have a moisture content of up to about 10.5 wt. %. In some embodiments, the fermented flour may have a moisture content between about 0.5 wt. % to 10.5 wt. %, about 1 wt. % to about 10 wt. %, about 1.5 wt. % to about 10 wt. %, about 2 wt. % to about 10 wt. %, about 2.5 wt. % to about 10 wt. %, about 3 wt. % to about 10 wt. %, about 3.5 wt. % to about 10 wt. %, about 3.75 wt. % to about 9.75 wt. %, about 4 wt. % to about 9.5 wt. %, about 4.25 wt. % to about 9.25 wt. %, about 4.5 wt. % to about 9.0 wt. %, about 4.75 wt. % to about 8.75 wt. %, or about 5 wt. % to about 8.5 wt. %. In some embodiments, the fermented flour may have a moisture content less than about 10.5 wt. %, less than about 10.0 wt. %, less than about 9.5 wt. %, less than about 9.0 wt. %, less than about 8.5 wt. %, less than about 8.0 wt. %, less than about 7.5 wt. %, less than about 7.0 wt. %, less than about 6.5 wt. %, less than about 6.0 wt. %, less than about 5.5 wt. %, or less than about 5.0 wt. %. In some embodiments, the moisture content of the fermented flour is at least about 3.5 wt. %, at least about 3.75 wt. %, at least about 4.0 wt. %, at least about 4.25 wt. %, at least about 4.50 wt. %, at least about 5.0 wt. %, or at least about 5.5 wt. %. In some embodiments, the moisture content of the fermented flour may have a moisture content of about 1 wt. %, about 1.25 wt. %, about 1.5 wt. %, about 1.75 wt. %, about 2 wt. %, about 2.25 wt. %, about 2.75 wt. %, about 3 wt. %, about 3.25 wt. %, about 3.5 wt. %, about 3.75 wt. %, or about 4 wt. %.

A dough that incorporates a fermented material and/or fermented flour may also have an altered texture profile. For example, a dough formed from dry ingredients comprising between about 70 wt. % to about 80 wt. % fermented chickpea flour exhibits a hardness between about 232 grams force to about 319 grams force. This is in stark contrast to a dough formed from dry ingredients comprising about 70 wt. % to about 80 wt. % of non-fermented chickpea flour, which exhibits a hardness of about 560 grams force.

### Flavor Compounds

The taste of the fermented flour is impacted, in part, by the concentration of flavor compounds present in the material from which the flour is derived. Flavor compounds include both off-flavor compounds and flavor-enhancing compounds. An exemplary list of flavor compounds are found in Table 7, below. Off-flavors (e.g., volatile compounds) can be inherent in flour material (e.g., a pulse such as a chickpea or a grain such as wheat) or can develop during harvesting, processing, or storage. The sources of volatiles are not completely understood, but the oxidation of lipids caused by heat or enzymatic processing is a known source. For example, one oxidation product of linolenic acid is c,t-3,5-Octadiene-2-one, which is correlated with shelf-life acceptability and a strong fatty, mushroom odor. Another, Nonanal, is an oxidation product of oleic acid. Nonanal exhibits a strong fatty odor and a fatty, citrus-like flavor. Furan,2-pentyl (also referred to as “2-pentylfuran”) is formed from the oxidation of 2,4-Decadienal and is associated with green, waxy, earthy, musty, and cooked odors and taste. (E,E)-2,4-Decadienal is an oxidation product of linoleic acid and produces a powerful green odor and a fatty, oily, and green taste. Finally, hexanal is another oxidation product of linoleic acid and results in a strong green, fatty, aldehydic odor and a green, woody, grassy taste.

Other flavor compounds can form as a result of a Maillard Reaction. The concentration of some of the flavor compounds associated with Maillard reactions (e.g., strecker aldehydes and pyrazines) are reduced following the disclosed fermentation methods. For example, the disclosed fermentation methods reduce the amount of 2,3-dimethyl-5-ethylpyrazine, an off-flavor compound associated with roasty burnt aromatic notes, particularly when compared to a non-fermented flour.

On the other hand, some flavor compounds impart desirable attributes (i.e., flavor-enhancing compounds) to the odor and taste of the fermented flour. Phenylacetaldehyde is associated with a strong green and honey odor and exhibits a sweet, chocolate, honey, floral taste. Pyrazine,3-ethyle-2,5-dimethyl- is a result of the Maillard Reaction and tends to provide an odor and taste of toasted notes. Interestingly, 2-methylbutanal, a flavor-enhancing compound associate with a malty aroma, may be produced during the disclosed fermentation methods.

Concentrations of flavor compounds categorized as esters, alcohol, and ketones may also be controlled. In some embodiments, the concentration of these flavor compounds increased compared to a non-fermented flour. For example, hexyl acetate and diisobutyl ketone, both associated with a fruity aroma, formed during the disclosed fermentation methods.

The fermented flour and/or fermented material may comprise about 0.5 ng/g to about 500 ng/g of hexanal, about 0.5 ng/g to about 450 ng/g hexanal, about 0.5 ng/g to about 400 ng/g of hexanal, or about 1 ng/g to about 500 ng/g of hexanal. In some embodiments, the fermented flour and/or fermented material comprises about 0.5 ng/g to about 10 ng/g of pentanal, about 0.5 ng/g to about 9.5 ng/g pentanal, or about 1 ng/g to about 10 ng/g pentanal. The fermented flour and/or fermented material may comprise about 0.001 ng/g to about 0.5 ng/g of decanal, about 0.005 ng/g to about 0.5 ng/g decanal, about 0.01 ng/g to about 0.5 ng/g of decanal, or about 0.015 ng/g to about 0.5 ng/g of decanal.

The fermented flour and/or fermented material may comprise about 0.5 ng/g to about 40 ng/g of heptanal, about 0.5 ng/g to about 35 ng/g of heptanal, about 1 ng/g to about 40 ng/g of heptanal, or about 1 ng/g to about 35 ng/g of heptanal.

The fermented flour and/or fermented material may comprise about 0.0001 ng/g to about 0.5 ng/g of decanal, about 0.001 ng/g to about 0.5 ng/g of decanal, or about 0.01 ng/g to about 0.5 ng/g of decanal. The fermented flour and/or fermented material may comprise about 0.001 ng/to about 30 ng/g of nonanal, about 0.005 ng/g to about 30 ng/g of nonanal, about 0.01 ng/g to about 30 ng/g of nonanal, or about 0.05 ng/g to about 25 ng/g of nonanal.

The fermented flour and/or fermented material may comprise about 10 ng/g to about 100 ng/g of Benzaldehyde, about 10 ng/g to about 95 ng/g of Benzaldehyde, about 10 ng/g to about 90 ng/g of Benzaldehyde.

The fermented flour and/or fermented material may comprise about 0.001 ng/g to about 25 ng/g of 3-methylbutanal, about 0.005 ng/g to about 25 ng/g of 3-methylbutanal, about 0.01 ng/g to about 25 ng/g of 3-methylbutanal, or about 0.05 ng/g to about 25 ng/g of 3-methylbutanal.

The fermented flour and/or fermented material may comprise about 0.01 ng/g to about 3 ng/g, about 0.05 ng/g to about 5 ng/g, or about 1 ng/g and about 3 ng/g of 2,3-dimethyl-5ethylpyrazine. In some embodiments, the fermented flour and/or fermented material comprises about 0.001 ng/g, to about 10 ng/g, about 0.01 ng/g to about 10 ng/g, or about 0.1 ng/g to about 10 ng/g of methylpyrazine.

The fermented flour and/or fermented material may comprise about 0.001 ng/g to about 10 ng/g, about 0.01 ng/g to about 10 ng/g, or about 0.1 ng/g to about 10 ng/g of trans,trans-2,4-octadienal. In some embodiments, the fermented flour and/or fermented material may comprise about 0.0001 ng/g to about 1 ng/g of pentanal, about 0.001 ng/g to about 1 ng/g of pentanal, or about 0.01 ng/g to about 1 ng/g of pentanal.

The fermented flour and/or fermented material may comprise about 0.001 ng/g to about 5 ng/g, about 0.01 ng/g to about 5 ng/g, or about 1 ng/g to about 5 ng/g of phenylacetaldehyde.

The fermented flour and/or fermented material may comprise about 0.001 ng/g to about 0.5 ng/g, about 0.005 ng/g to about 0.5 ng/g, or about 0.01 ng/g to about 0.5 ng/g of methyl acetate. The fermented flour and/or fermented material comprises about 0.001 ng/g to about 10 ng/g, about 0.005 ng/g to about 10 ng/g, or about 0.01 ng/g to about 10 ng/g of 1-pentanol.

The fermented flour and/or fermented material may comprise between about 0.01 ng/g to about 550 ng/g, about 0.1 ng/g to about 500 ng/g, or about 1 ng/g to about 500 ng/g of diisobutyl ketone. The fermented flour and/or fermented material may comprise about 0.0001 ng/g to about 500 ng/g, about 0.001 ng/g to about 500 ng/g, or about 0.005 ng/g to about 500 ng/g of hexanal.

The fermented material and/or fermented flour may have less than about 50 ng/g of pentanal, less than about 1000 ng/g of hexanal, less than about 75 ng/g of heptanal, less than about 1 ng/g of decanal, less than about 100 ng/g 3-methylbutanal, less than about 60 ng/g phenylacetaldehyde, or less than about 100 ng/g 2,5-dimethylpyrazine. In some embodiments, the concentration of oxidation lipid products in the fermented material and/or fermented flour as compared to the concentration of oxidation lipid products in the starting flour may be reduced by about 10%, about 15%, about 20%, about 25%, about 30%, about 35%, about 40%, about 45%, about 50%, about 55%, about 60%, about 65%, about 70%, about 75%, about 80%, or about 85%. The hexanal concentration in the fermented material and/or fermented flour as compared to the hexanal concentration in the starting flour may be reduced by about 30%, about 35%, about 40%, about 45%, about 50%, about 55%, about 60%, about 65%, about 70%, about 75%, about 80%, about 85%, about 90%, about 95%, about 99%, or about 100%.

The following are exemplary embodiments of the disclosed methods and fermented flours formed using the disclosed methods.

A fermented chickpea flour resulting from a starting chickpea flour that was fermented using Streptococcus thermophilus, Lactobacillus delbrueckii subsp. bulgaricus, Lactobacillus delbrueckii subsp. lactis, Bifidobacterium lactis, and Lactobacillus acidophilus may contain a lower concentration of lipid oxidation products compared to the starting flour. For example, pentanal may be reduced to about 1 ng/g, hexanal may be reduced to about 100 ng/g, heptanal may be reduced to about 10 ng/g, benzaldehyde may be reduced to about 90 ng/g to 110 ng/g, trans,trans-2,4-octadienal may be reduced to about 8 ng/g, nonanal may be reduced to about 9 ng/g, and decanal may be reduced to about 0 ng/g to about 0.05 ng/g. Further, in this fermented chickpea flour, 3-methylbutanal may be reduced to about 1 ng/g to about 5 ng/g, phenylacetaldehyde may be reduced to about 1 ng/g to about 5 ng/g, methylpyrazine may be reduced to about 7 ng/g to about 10 ng/g, 2,5-dimethylpyrazine may be reduced to about 20 ng/g to 60 ng/g, and 2,3-dimethyl-5-ethylpyrazine may be reduced to about 0.5 ng/g to about 1.5 ng/g. Finally, in this fermented chickpea flour, methyl acetate may be reduced to about 0 ng/g to about 0.1 ng/g, and 1-penten-3-ol may be reduced to about 1 ng/g to about 5 ng/g.

A fermented chickpea flour resulting from a starting chickpea flour that was fermented using a mixture of Lactobacillus acidophilus, Lactobacillus paracasei, Lactobacillus casei, and Lactobacillus plantarum may contain a lower concentration of lipid oxidation products compared to the starting chickpea flour. For example, pentanal may be reduced to about 0.5 ng/g to about 1 ng/g, hexanal may be reduced to about 25 ng/g to about 55 ng/g, heptanal may be reduced to about 5 ng/g to about 10 ng/g, benzaldehyde may be reduced to about 90 ng/g to about 110 ng/g, trans,trans-2,4-octadienal may be reduced to about 1 ng/g to about 5 ng/g, nonanal may be reduced to about 2 ng/g to about 5 ng/g, decanal may be reduced to about 0 ng/g to about 0.05 ng/g, and trans,trans-2,4-nonadienal may be reduced to about 0 ng/g to about 0.05 ng/g. Further, in this fermented chickpea flour, 3-methylbutanal may be reduced to about 0.5 ng/g to about 1 ng/g, phenylacetaldehyde may be reduced to about 1 ng/g to about 5 ng/g, methylpyrazine may be reduced to about 7 ng/g to about 10 ng/g, 2,5-dimethylpyrazine may be reduced to about 20 ng/g to 60 ng/g, and 2,3-dimethyl-5-ethylpyrazine may be reduced to about 0.5 ng/g to about 1.5 ng/g. Finally, in this fermented chickpea flour, methyl acetate may be reduced to about 0 ng/g to about 0.1 ng/g, 1-penten-3-ol may be reduced to about 0.1 ng/g to about 0.6 ng/g, and 1-pentanol may be reduced to about 7 ng/g to about 10 ng/g.

A fermented chickpea flour resulting from a starting chickpea flour that was fermented using a Lactococcus lactis ssp. lactis, may contain a lower concentration of lipid oxidation products compared to the starting chickpea flour. For example, pentanal may be reduced to about 2 ng/g to about 6 ng/g, hexanal may be reduced to about 200 ng/g to about 600 ng/g, heptanal may be reduced to about 20 ng/g to about 50 ng/g, and benzaldehyde may be reduced to about 70 ng/g to about 100 ng/g. Further, in this fermented chickpea flour, 3-methylbutanal may be reduced to about 1 ng/g to about 5 ng/g, phenylacetaldehyde may be reduced to about 5 ng/g to about 10 ng/g, methylpyrazine may be reduced to about 7 ng/g to about 10 ng/g, 2,5-dimethylpyrazine may be reduced to about 20 ng/g to about 60 ng/g, and 2,3-dimethyl-5-ethylpyrazine may be reduced to about 0.5 ng/g to about 1.5 ng/g. Finally, in this fermented chickpea flour, methyl acetate may be reduced to about 0 ng/g to about 0.1 ng/g, and 1-penten-3-ol may be reduced to about 1 ng/g to about 5 ng/g.

A fermented chickpea flour resulting from a starting chickpea flour that was fermented using Kluyveromyces marxianus, may contain a lower concentration of lipid oxidation products compared to the starting chickpea flour. For example, pentanal may be reduced to about 0.20 ng/g to 1 ng/g, hexanal may be reduced to about 50 ng/g to about 80 ng/g, heptanal may be reduced to about 10 ng/g to about 40 ng/g, benzaldehyde may be reduced to about 10 ng/g to about 50 ng/g, trans-2-heptenal may be reduced from about 1 ng/g to about 5 ng/g, nonanal may be reduced to about 0 ng/g to about 0.5 ng/g, decanal may be reduced to about 0 ng/g to about 0.5 ng/g, and trans-2-decenal may be reduced to about 1 ng/g to about 3 ng/g. Further, in this fermented chickpea flour, 3-methylbutanal may be reduced to about 10 ng/g to about 40 ng/g, phenylacetaldehyde may be reduced to about 10 ng/g to about 40 ng/g, methylpyrazine may be reduced to about 7 ng/g to about 10 ng/g, 2,5-dimethylpyrazine may be reduced to about 20 ng/g to about 50 ng/g, and 2,3-dimethyl-5-ethylpyrazine may be reduced to about 0.5 ng/g to about 1 ng/g. Finally, in this fermented chickpea flour, 1-penten-3-ol may be reduced to about 0.1 ng/g to about 0.8 ng/g, and 1-pentanol may be reduced to about 2 ng/g to about 7 ng/g.

The following Examples demonstrate the fermentation methods and fermented flours formed from a starting chickpea flour.

### EXAMPLES AND METHODOLOGY

### Example 1: Fermented Chickpea Flour

The concentration of flavor compounds present in a fermented flour were compared to the concentration of the same flavor compounds in a starting flour sample. The fermented flour was prepared according to the following method. Several mixtures of 600 g of a mixture containing 60 wt. % water and 40 wt. % extruded chickpea flour (i.e., the starting flour) were prepared. After combining, the mixtures were divided into five samples and seeded with one or more microorganisms as shown in Table 1. In some embodiments, an optional step of sterilizing can be skipped if, for example, the starting material was already sterilized. The one or more microorganisms were seeded in an amount of about 0.06 billion to 120 billion CFU per 100 g of mixture. The one or more microorganisms were allowed to ferment under solid state conditions at a temperature of about 90° F. to about 110° F. (about 32.22° C. to about 43.33° C.) or room temperature, for about 4 or about 17 hours. As shown in the figures and data below, samples were taken at different time points to understand the impact of fermentation parameters (e.g., time, temperature, microorganism) on the resulting flavor compound concentrations.

TABLE 1
Experimental Design for High-solid State Fermentation of Chickpea Mixture

| | | Mixture | CFU/ | | Fermentation | |
|---|---|---|---|---|---|---|
| No. | Microorganism | content | 100 g | | (° F.) | time (hrs) |
| 1 | None/Non-fermented | ~40 wt. % | 0 | | — | 4 |
| | | extruded | | | | 17 |
| 2 | Streptococcus | chickpea | 120 | billion | 110 | 4 |
| | thermophilus/ | flour + ~60 | | | | 17 |
| | Lactobacillus delbrueckii | wt. % | | | | |
| | subsp. bulgaricus/ | water | | | | |
| | Lactobacillus delbrueckii | | | | | |
| | subsp. lactis/ | | | | | |
| | Bifidobacterium lactis/ | | | | | |
| | Lactobacillus acidophilus | | | | | |
| 3 | Lactobacillus acidophilus/ | | 120 | billion | 100 | 4 |
| | Lactobacillus paracasei/ | | | | | 17 |
| | Lactobacillus casei/ | | | | | |
| | Lactobacillus plantarum | | | | | |
| 4 | Lactococcus lactis ssp. | | 1.2 | billion | 90 | 4 |
| | lactis | | | | | 17 |
| 5 | Kluyveromyces | | 0.06 | billion | 90 | 4 |

| | |
|---|---|
| marxianus | 17 |

Microorganisms used in Sample No. 2 were obtained from DUPONT and sold under the brand name VEGE 053. Microorganisms used in Sample No. 3 were obtained from DUPONT and sold under the brand name VEGE 011. The microorganisms used in Sample No. 4 were obtained from SACCO and sold under the brand name LYOFAST V MO 01. Finally, the microorganisms used in Sample No. 5 were obtained from SACCO and sold under the brand name KLYVEROMYCES MARXIANUS SSP. FRAGILIS B0399.

In addition and as shown below in Table 2, the type of microorganism (s) selected impacts the concentration of various organic acids within the fermented material, which results in different sensory attributes. Each mixture contained about 40 wt. % chickpea flour with pre-gelled starch and about 60 wt. % water. Each mixture was fermented according to the parameters of Table 1. The industry accepted sensory attribute for each organic acid is as follows: lactic acid is a yogurt/buttery note, formic acid is a vanilla note, citric acid is a tart/refreshing note, and acetic acid is a vinegary note. The type of flavor notes desired may change depending on the purpose of the fermented flour.

TABLE 2
Microorganism(s) impact on organic
acid profiles of fermented material

| Sample | | | | | |
|---|---|---|---|---|---|
| No. | 1 | 2 | 3 | 4 | 5 |
| pH | 5.9 | 4.4 | 4.8 | 5.0 | 5.9 |
| Lactic acid | — | 1250 | 537 | 519 | — |
| (mg/100 g) | | | | | |
| Formic | 43.2 | 102 | 634 | 74.8 | 57.2 |
| acid | | | | | |
| (mg/100 g) | | | | | |
| Citric acid | 198.4 | 166 | — | — | 171 |
| (mg/100 g) | | | | | |
| Acetic acid | 7.5 | 107 | 33.3 | 13.8 | 2.5 |
| (mg/100 g) | | | | | |

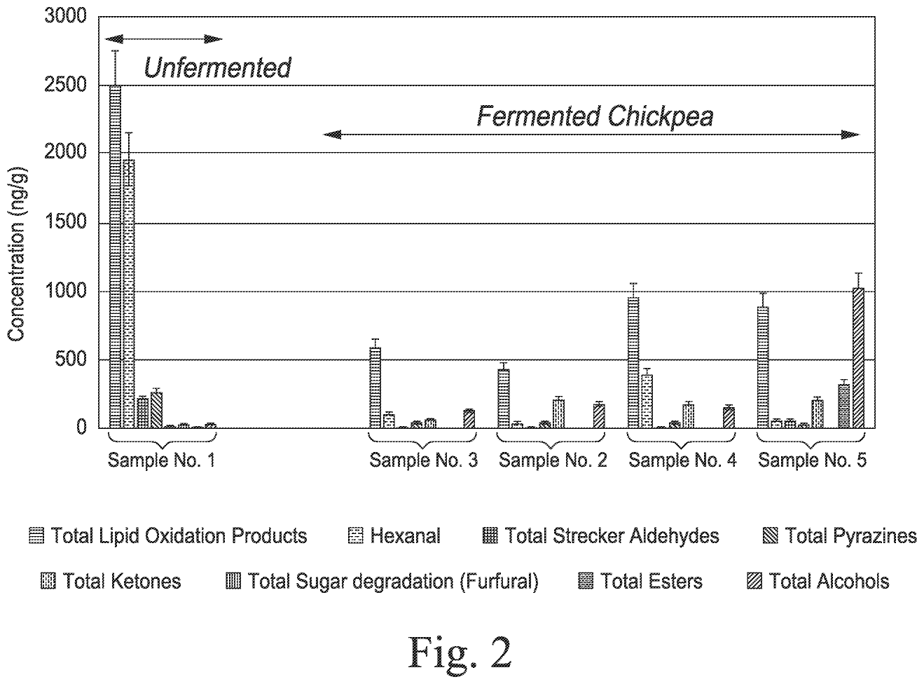

Fermentation resulted in a reduction of compounds related to off-flavor notes in chickpea as shown in FIG. 2. For example, the concentration of lipid oxidation products, including hexanal, was significantly reduced regardless of the microorganism used; however, between microorganisms there was a difference in the final concentration of lipid oxidation products and specifically hexanal. The concentrations of various flavor compounds, including total lipid oxidation products, total strecker aldehydes, and total pyrazines, were analyzed using gas chromatography/mass spectrometry.

Additionally, FIG. 2 shows that the concentration of flavor compounds changes depending on the type of seeded microorganism. In that regard, Table 3 quantifies the percentage of reduction or increase in the concentration of different flavor compounds shown in FIG. 2.

TABLE 3
Changes in concentrations of flavor compounds in
fermented material compared to the starting flour.

| | % change compared to | Increase (+) |
|---|---|---|
| Flavor Compound | the starting flour | Reduction (−) |
| Total Lipid Oxidation | 60-80 | − |
| Products | | |
| Hexanal | 70-99 | − |
| Total Strecker Aldehydes | 70-98 | − |
| Total Pyrazines | 85-90 | − |
| Total Ketones | 200-400 | + |
| Total sugar degradation | 85-99 | − |
| Total Esters | 275-325 | + |
| Total Alcohols | 400-3700 | + |

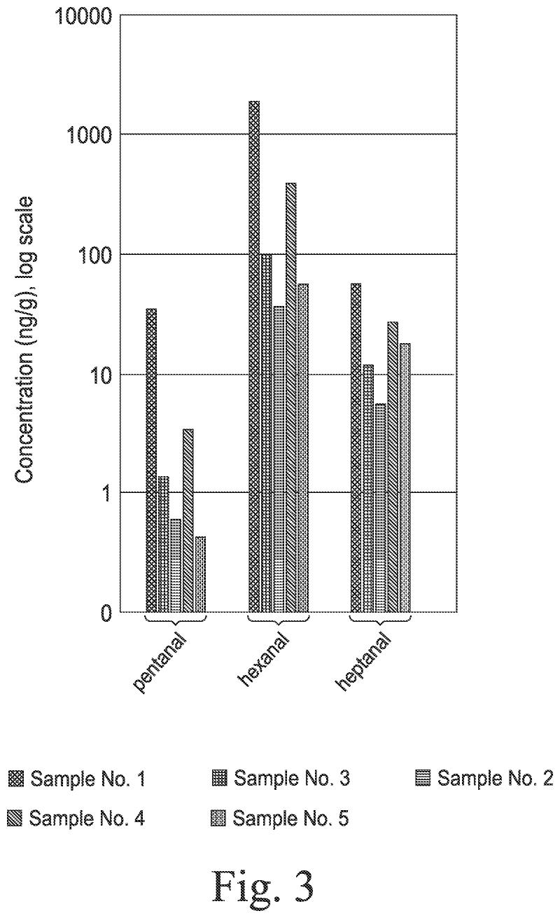

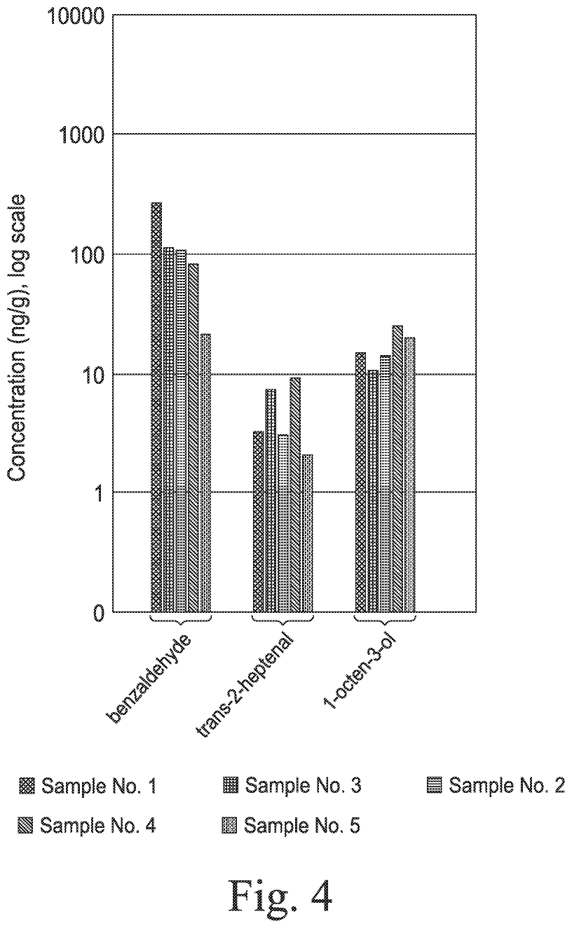

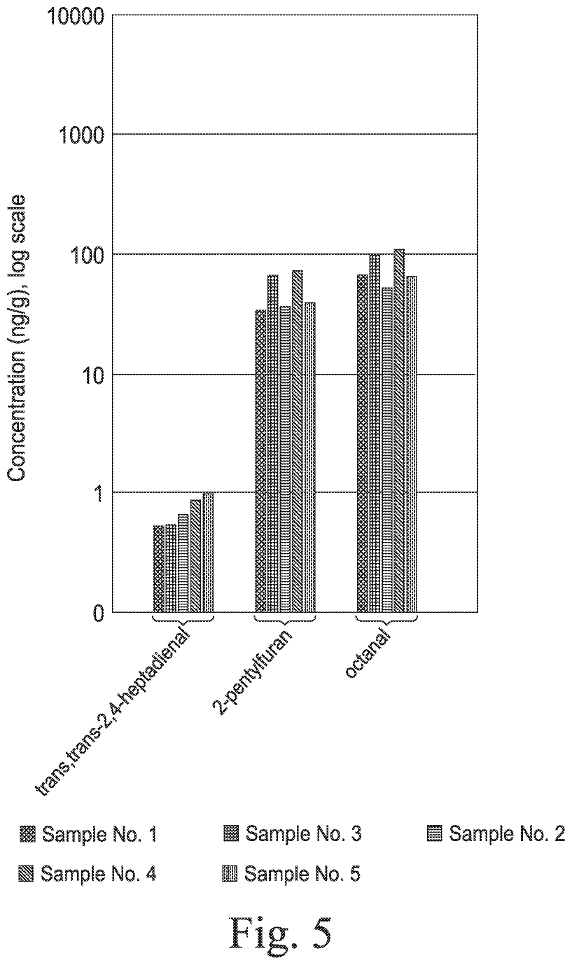

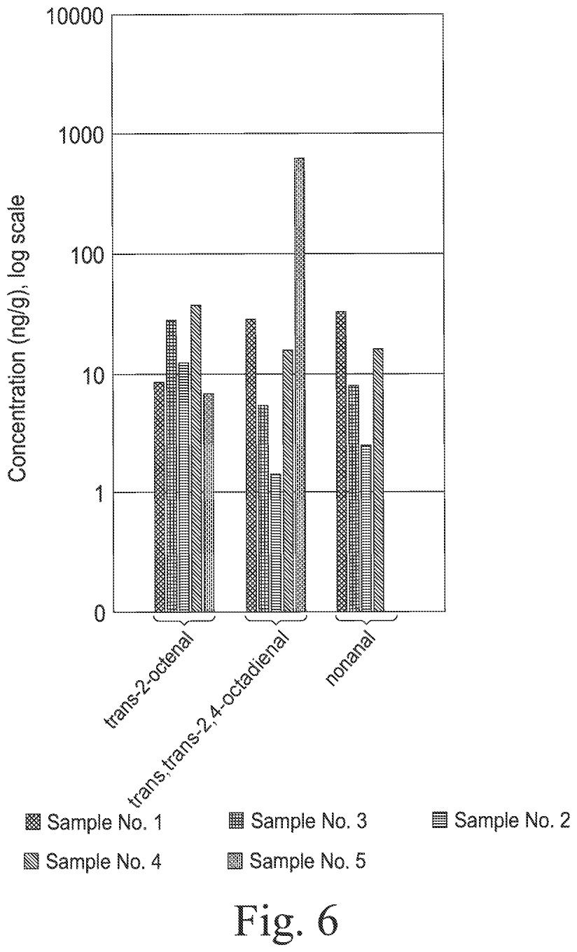

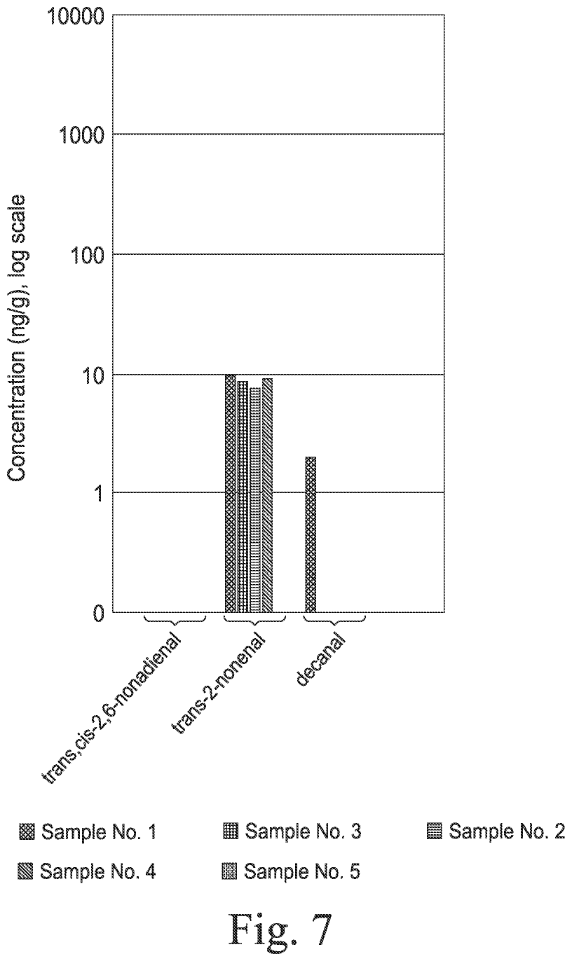

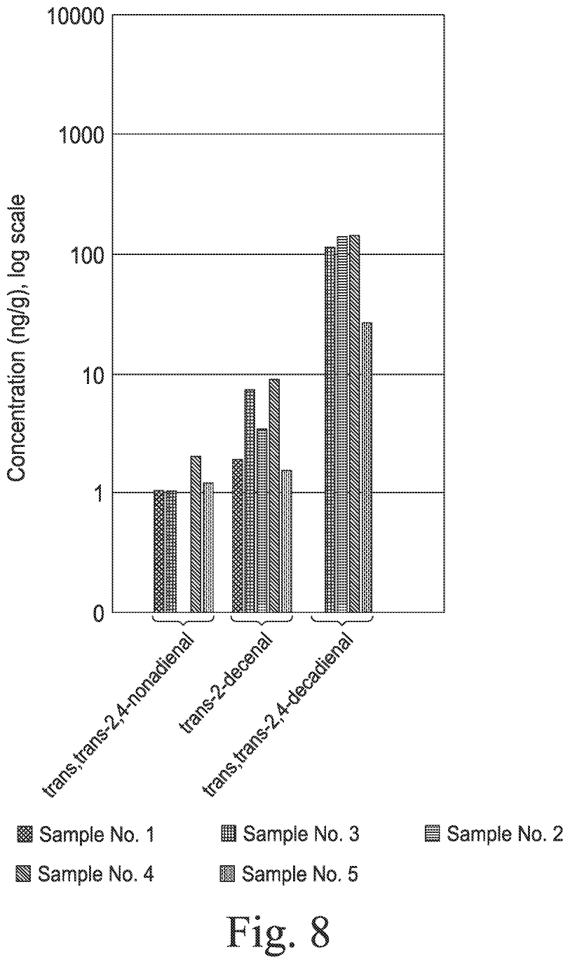

If there is a desire to reduce the concentration of a specific flavor compound (e.g., pentanal, hexanal, nonanal, or decanal), the fermentation method may be tuned or modified to control the concentration of specific flavor compound(s). FIG. 3 through FIG. 8, depict graphs comparing the concentration of lipid oxidation products from mixtures formed using 40 wt. % extruded chickpea flour (60 wt. % water) and fermented according to the described methods using the microorganisms identified in Sample Nos. 1, 2, 3, 4, and 5 of Table 1. As FIG. 3 through FIG. 8 show, the concentration of specific flavor compounds can be altered depending on the type or combinations of microorganisms used. Beneficially, all the microorganisms were capable of reducing heptanal, which is associated with a rancid aroma.

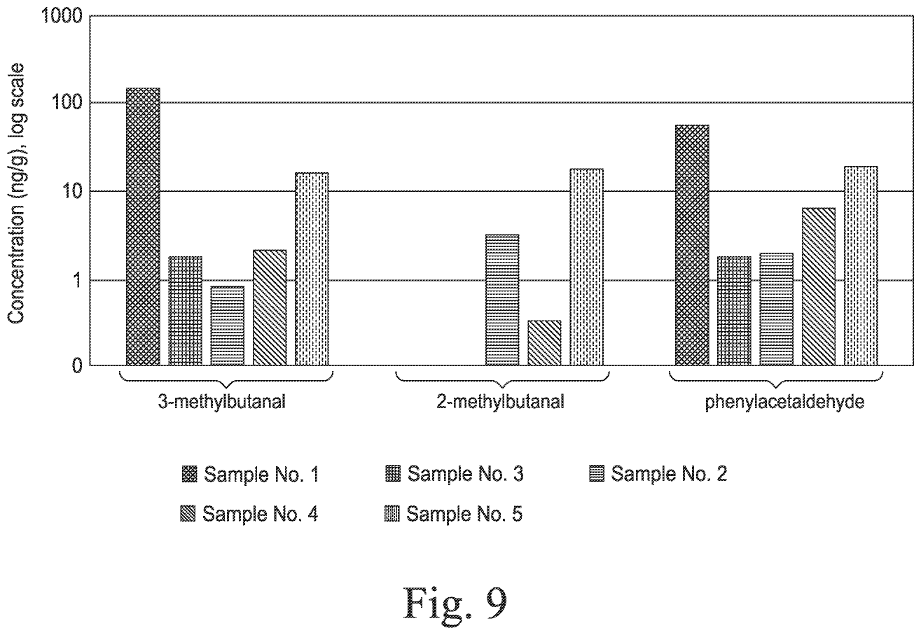

Analysis of various flavor compounds showed that the concentration of compounds associated with a Maillard Reaction were reduced through the disclosed methods of fermentation. As shown in FIG. 9, the concentration of 3-methylbutanal and phenylacetaldehyde were reduced compared to a non-fermented sample (i.e., Sample No. 1). Interestingly, FIG. 9 shows that 2-methybutanal was not present in the starting chickpea flour material, but was formed during fermentation of Sample Nos 3, 4, and 5. 2-methyldbutanal, a flavor-enhancing compound, is associated with a malty aroma.

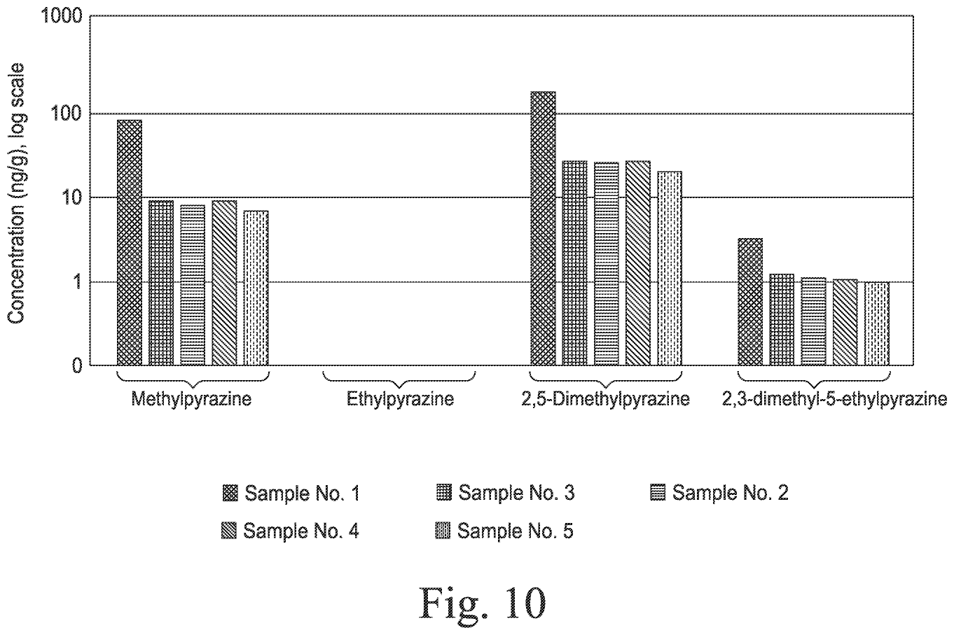

The graph in FIG. 10, shows that the disclosed fermentation methods reduced the concentration of pyrazine compounds. Specifically, the concentration of methylpyrazine, 2,5-dimethylpyrazine, and 2,3-dimethy-5-ethylpyrazine were reduced in the fermented flours compared to the non-fermented flour. Ethylpyrazine was not present in the non-fermented flour and was not formed during the fermentation process. Beneficially, the concentration of 2,3-dimethyl-5-ethylpyrazine, a compound having a roasty, burnt aroma characteristic, was reduced in all fermentation samples compared to the non-fermented chickpea flour (Sample No. 1). While even some of the Strecker aldehydes and pyrazine compounds have pleasant aroma scents, in some instances it may be advantageous to reduce the presence of flavor compounds. For example, by reducing the presence of both off-flavor and flavor-enhancing compounds, the fermented flour may be used as a nutritional additive that does not substantially alter the flavor profile of a food to which the fermented flour is added. Accordingly, less fat and/or sugar or sweeteners may be needed to mask flavor compounds in a dough or food product prepared using the disclosed fermented materials and fermented flours.

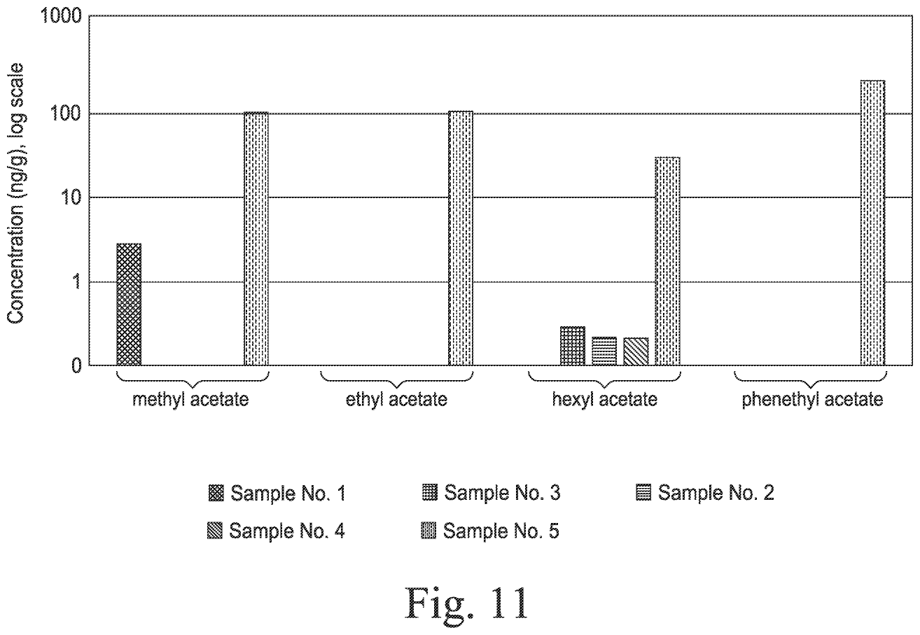

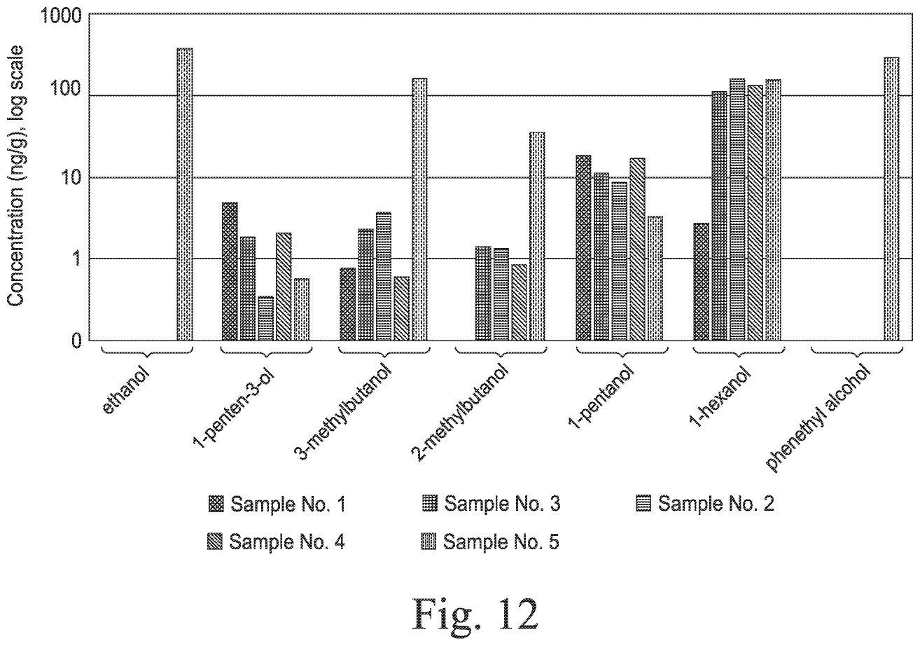

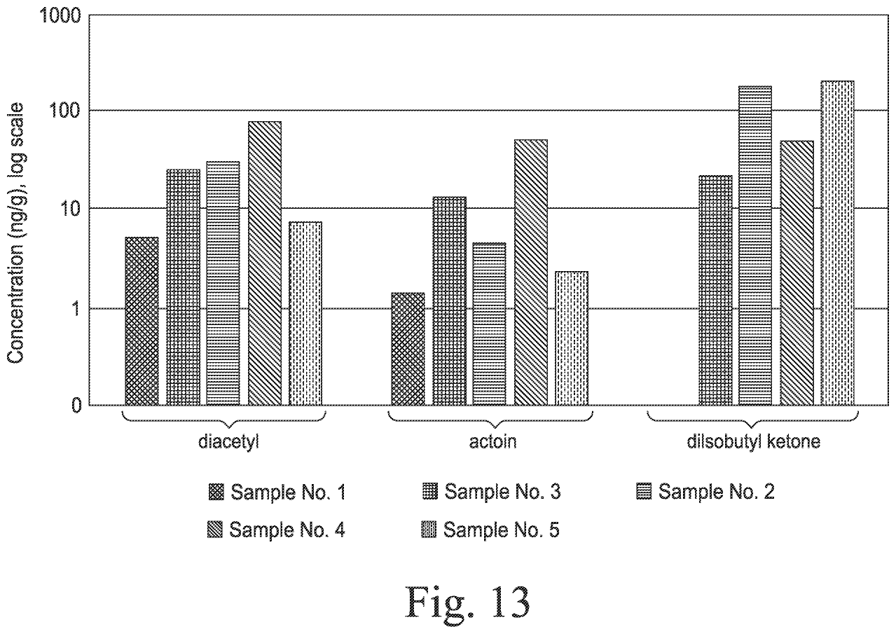

Turning to FIGS. 11, 12, and 13, it is seen that there was an overall increase in the concentration of esters, alcohol, and ketones in the fermented mixtures compared to the non-fermented mixture. FIG. 11 shows the concentration of measured ester compounds. When using Kluyveromyces marxianus (Sample No. 5) to ferment the flour, methyl acetate, ethyl acetate, hexyl acetate, and phenethyl acetate were produced or their concentration increased. However, with the exception of hexyl acetate, none of the other fermented samples contained any of the quantified esters. FIG. 12 shows the concentration of measured alcohol compounds. The type of microorganism chosen to ferment the chickpea flour resulted in a modification of the type of alcohol present. The modification could include an increase, decrease, or production of an alcohol where none initially existed. FIG. 13 shows the concentration of measured ketone compounds. Generally, the ketone compounds were produced or their concentration increased after fermentation compared to non-fermented chickpea flour. Depending on the organoleptic properties desired, the skilled artisan can seed a mixture with one or more selected microorganisms to control the concentration of various compounds. For example a higher concentration of alcohol in a fermented flour could provide a positive flavor to the subsequently formed snack.

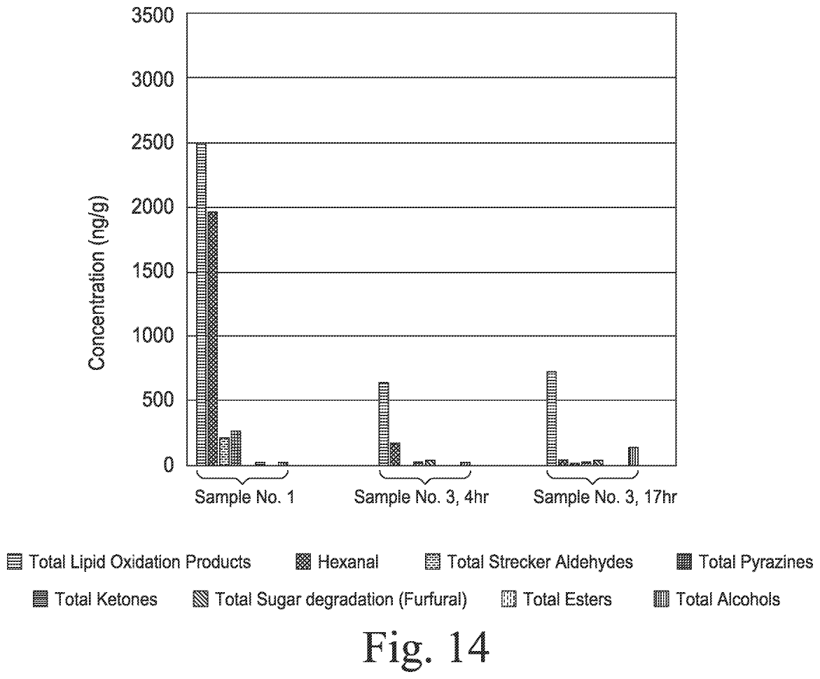

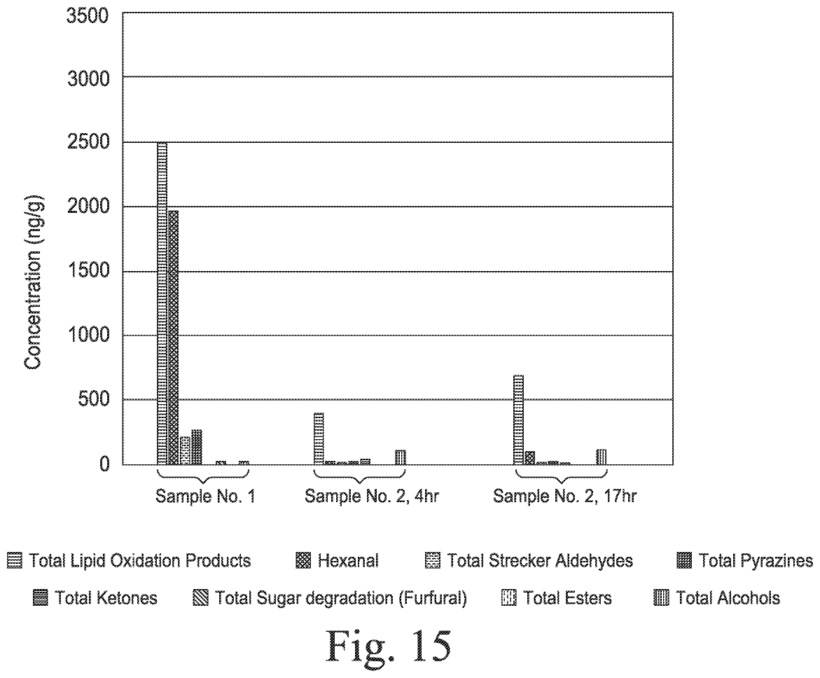

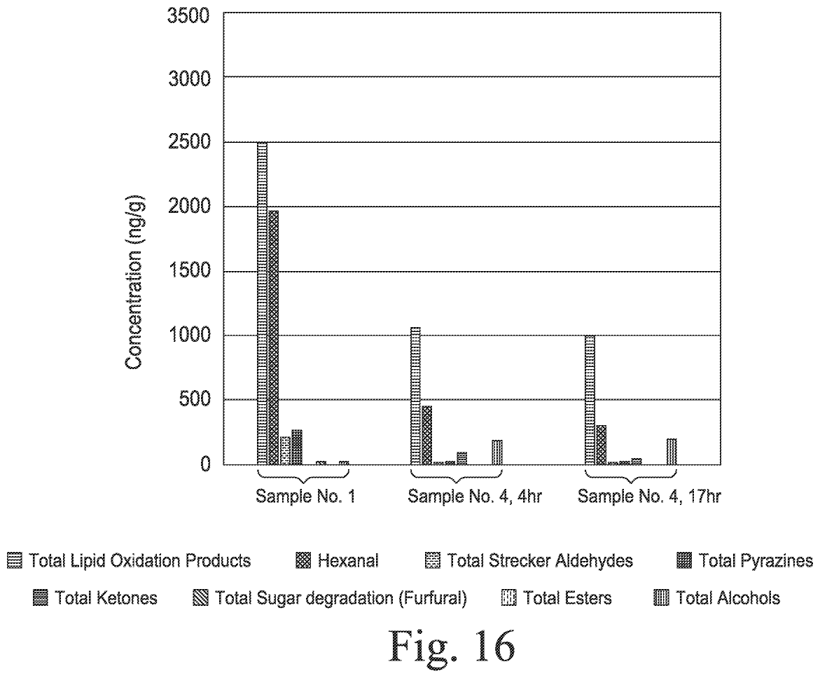

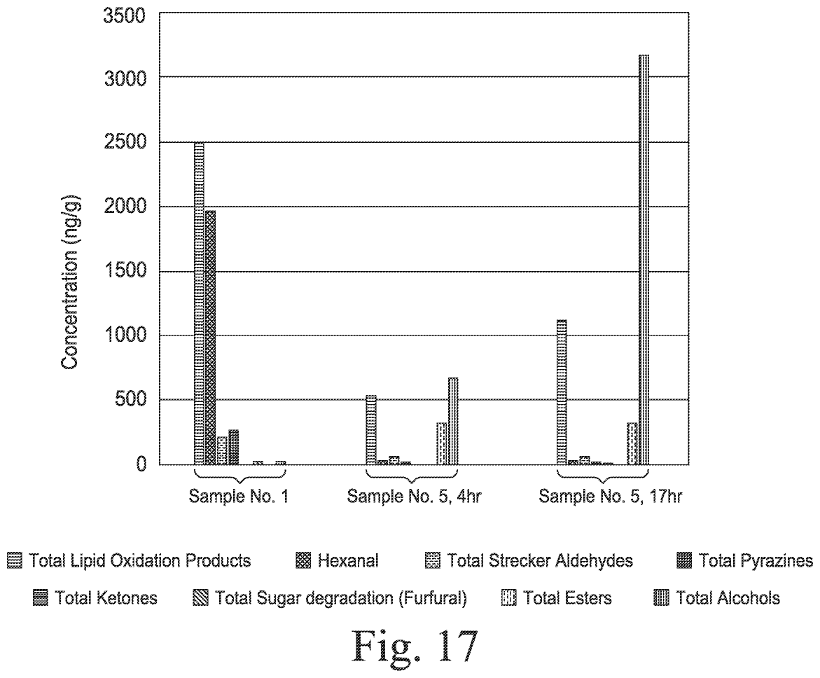

It was also found that time and heat impacted the concentration of flavor compounds in some of the fermented mixtures. Turning to FIGS. 14 to 17, the impact of time on the concentration of flavor compounds was evaluated. Each mixture was fermented for about four hours or for about seventeen hours and then compared to a non-fermented sample. Overall, the concentration of total lipid oxidation products is reduced for all fermented mixtures. Fermenting for seventeen hours increased the concentration of total lipid oxidation products, Maillard reaction compounds, strecker aldehydes, pyrazines, and sugar degradation compounds for Sample Nos. 3 and 5 to some degree. However, fermented Sample Nos. 2 and 4 did not show a significant change in the previously mentioned compounds when fermented for four hours as compared to fermentation for seventeen hours.

### Example 2: Chickpea Cracker Formed from Fermented Chickpea Flour

Chickpea crackers were formed from a fermented chickpea flour made according to the described methods and additional ingredients as provided in Table 4.

TABLE 4
Exemplary Ingredients to make chickpea crackers.

| Ingredient | Wt. % |
|---|---|
| Fermented/Chickpea flour | ~41 |
| Potato, wheat, or rice flour | ~6 |
| Pregelled Corn Starch | ~4 |
| Salt | ~0.1 |
| Sodium bicarbonate | ~0.5 |
| Sunflower oil | ~1 |
| Water | ~48 |

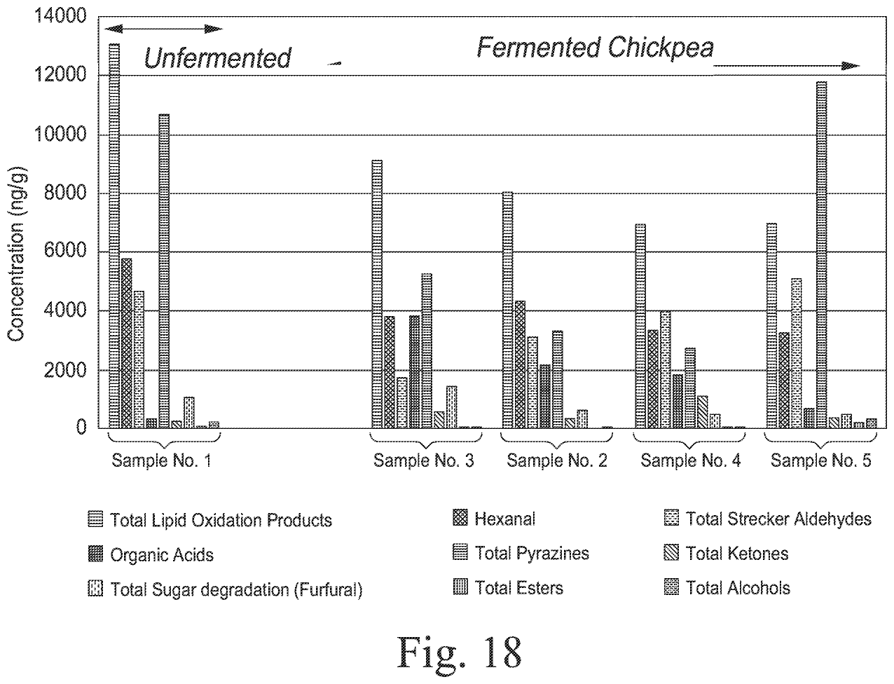

When chickpea crackers were produced using about 80% fermented chickpea flour (i.e., the percent of fermented chickpea flour of the total dry ingredients is about 80%), the fermented chickpea crackers contained lower concentrations of off-flavors as compared to a cracker containing the same ingredients except the fermented chickpea flour is replaced with the starting chickpea flour. Turning to FIG. 18, the graph shows that when a majority of the starting ingredients contain less off-flavors, then the finished food product also has less off-flavors even though some off-flavors may be produced during the baking process. Table 5 quantifies the percentage of reduction or increase in the concentration flavor compounds when a fermented flour is used as compared to food products containing a non-fermented flour and the results are shown in FIG. 18.

TABLE 5
Changes in concentrations of flavor compounds in a chickpea
cracker comparing fermented flour (Sample Nos. 2, 3, 4, and 5)
to non-fermented flour (Sample No. 1).

| | % change | |
|---|---|---|
| | compared to non- | |
| Flavor | fermented | Increase (+) |
| compound | chickpea | Reduction (−) |
| Total Lipid Oxidation | 30-50 | − |
| Products | | |
| Hexanal | 25-45 | − |
| Total Strecker Aldehydes | 10-60 | − |
| Total Pyrazines | 50-70 | − |
| Total Ketones | 40-350 | + |
| Total sugar degradation | 40-50 | − |
| Total Esters | 50-60 | −/(+ only for KM + 280) |
| Total Alcohols | 0-50 | + |

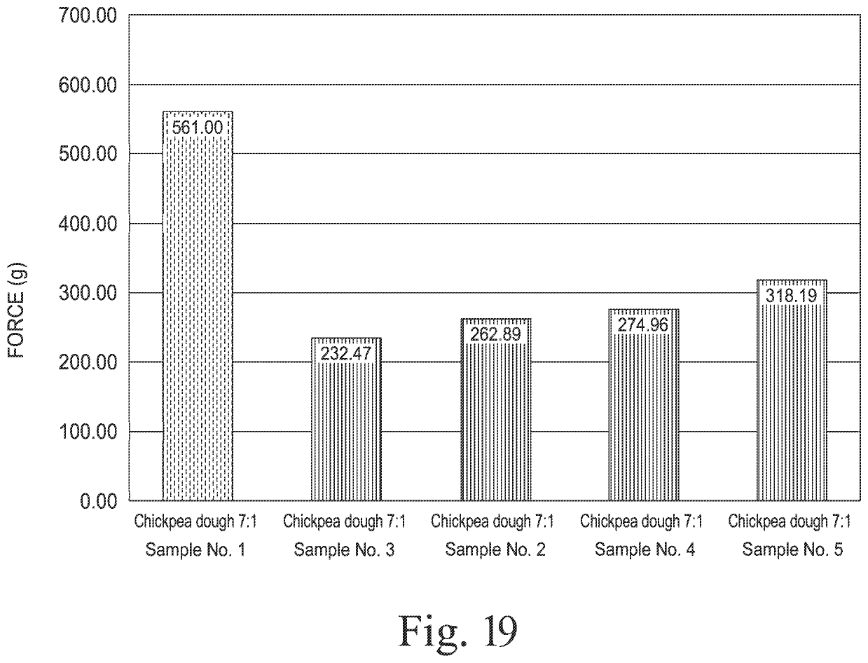

When fermented chickpea flour is incorporated into dough to form a cracker, the texture changes compared to a similar cracker made from starting chickpea flour. The difference in texture is noticeable in the dough as demonstrated in FIG. 19. Even in the dough phase, the fermented chickpea flour exhibits a reduced force required to compress the dough than that required to compress the non-fermented dough to the same depth.

The texture differences remained even after the dough was baked to form crackers. A hardness test was performed to test the difference in force required to crack a cracker made from non-fermented chickpea flour and a cracker comprising fermented chickpea flour. The results show that generally the non-fermented chickpea crackers required more force to produce a crack in the chickpea crackers. A Texture Technologies TA.XT.Plus was used to perform a three-point bend test. A bending fixture probe was used to measure the force required to bend the cracker until it broke. The analysis was performed at room temperature and one cracker was used per test. The results of the hardness test are provided in Table 6.

A person having ordinary skill in the art will appreciate that any pre-processing of the starting flour (i.e., non-fermented flour) may impact the initial concentration levels of various flavor compounds. For example, commercially available non-fermented, pre-gelled flour contained very low concentrations of pyrazines and furfural (i.e., sugar degradation), and a lower concentration of esters compared to a commercially available extruded non-fermented flour. The non-fermented extruded flour contained more alcohol compared to the non-fermented pre-gelled flour. Depending on the desired end product, the starting flour, the type of the one or more microorganism, and the solid state fermentation conditions can be adjusted as demonstrated herein.

TABLE 6
Texture analysis showing the difference in hardness
in crackers from non-fermented chickpea compared
to fermented chickpea with different microorganisms.

| | % chickpea flour | | |
|---|---|---|---|
| | of total dry | Sample | |
| Flour | ingredients | No. | Grams force |
| Company | 80 | 1 | 1340 |
| A | | 2 | 760-765 |
| (pregelled) | | 3 | 685-690 |
| | | 4 | 385-390 |
| | | 5 | 565-570 |
| Company | 70 | 1 | 1595 |
| A | | 2 | 540-545 |
| (Pregelled) | | 3 | 1475-1480 |
| | | 4 | 925-930 |
| | | 5 | 1030-1035 |
| Company | 70 | 1 | 7045 |
| B | | 2 | 1125-1130 |
| (extruded) | | 3 | 870-875 |
| | | 4 | 1145-1150 |
| | | 5 | 1230-1235 |

TABLE 7
Compounds and Their Associated Aroma Characteristics.

| | |
|---|---|
| Compound | Aroma Characteristic |

Lipid Oxidation Products

| | |
|---|---|
| Pentanal | Beany |
| Hexanal | Beany |
| Heptanal | Rancid |
| Benzaldehyde | Sweet, woody, nutty |
| Trans-2-heptenal | Pungent green, fatty |
| 1-cten-3-ol | Beany, mushroom |
| Trans,trans-2,4-heptadienal | Beany |
| 2-pentylfuran | Fruity, green, sweet |
| Octanal | Soapy, sweet, waxy |
| Trans-2-octenal | Wood, fatty |
| Nonanal | Fatty aroma with citrus note |
| Trans,cis-2,6-nonadienal | Grassy |
| Trans-2-nonenal | Fatty |
| Decanal | Orange peel |
| Trans,trans-2,4-nonadienal | Beany |
| Trans-2-decenal | Fatty |
| Trans, trans-2,4-decadienal | Fatty, fried |

Strecker Aldehydes and Pyrazines

| | |
|---|---|
| 3-methylbutanal | Malty |
| 2-methylbutanal | Malty |
| Phenylacetaldehyde | Honey-like, sweet, green |
| Methylpyrazine | Nutty |
| Ethylpyrazine | nutty |
| 2,5-Dimethylpyrazine | Musty, nutty, grassy |
| 2,3-dimethyl-5-ethylpyrazine | Roasty, burnt |

Esters, Alcohols, and Ketones

| | |
|---|---|
| Methyl acetate | Fruity |
| Ethyl acetate | Fruity |
| Hexyl acetate | Sweet, fruity |
| Phenethyl acetate | Fruity, raspberry-like taste |
| Ethanol | Alcohol |
| 1-penten-3-ol | Green, vegetable, fruity |
| 3-methylbutanol | Whiskey |
| 2-methylbutanol | Mild alcohol |
| 1-pentanol | Wine |
| 1-hexanol | Fatty, green |
| Phenylethyl alcohol | Rose-like |
| Diacetyl | Buttery, fermented |
| Acetoin | Buttery, sweet |
| Diisobutyl ketone | Fruity, peppermint |

Sugar Degradation

| | |
|---|---|
| Furfural | Almond-like |

While the concepts of the present disclosure are susceptible to various modifications and alternative forms, specific exemplary embodiments of the disclosure have been shown by way of example. It should be understood, however, that there is no intent to limit the concepts of the present disclosure to the particular disclosed forms; the intention is to cover all modifications, equivalents, and alternatives falling within the spirit and scope of the invention as defined by the claims. Although this disclosure refers to specific embodiments, it will be understood by those skilled in the art that various changes in form and detail may be made without departing from the subject matter set forth in the accompanying claims.

1. A fermented flour comprising:
less than about 500 ng/g of hexanal,
less than about 10 ng/g of pentanal,
less than 0.5 ng/g of decanal; and,
one or more deactivated microorganisms selected from the group consisting of Lactobacillus Lactis, Streptococcus thermophiles, Lactobacillus delbrueckii, Lactobacillus acidophilus, Lactobacillus paracasei, Lactobacillus casei, Bifidobacterium animalis, Lactobacillus rhamnosus, Lactococcus lactis ssp. lactis, Lactococcus lactis ssp., Lueconostoc mesenteroids, Lactococcus lactis ssp. lactis, Lactobacillus sakei, Lactobacillus planetarium, and Kluyveromyces marxianus
wherein the fermented flour has a moisture content less than about 6.5%.

2. The fermented flour of claim 1 further comprising:
less than about 40 ng/g of heptanal;
less than 0.5 ng/g of decanal;
less than about 30 ng/g of nonanal;
between about 10 ng/g to about 100 ng/g of Benzaldehyde;
less than about 25 ng/g of 3-methylbutanal;
between about 1 ng/g and about 3 ng/g of 2,3-dimethyl-5-ethylpyrazine; and
less than about 10 ng/g of methylpyrazine.

3. The fermented flour of claim 1 further comprising less than about 10 ng/g of trans,trans-2,4-octadienal.

4. The fermented flour of claim 1, wherein the fermented flour has less than about 1 ng/g of pentanal.

5. The fermented flour of claim 1 further comprising about 1 ng/g to about 5 ng/g of phenylacetaldehyde.

6. The fermented flour of claim 1 further comprising less than about 0.5 ng/g of methyl acetate.

7. The fermented flour of claim 1 further comprising less than about 10 ng/g of 1-pentanol.

8. The fermented flour of claim 1 further comprising between about 1 ng/g to about 500 ng/g of diisobutyl ketone.

9. The fermented flour of claim 1, wherein the fermented flour includes chickpeas.

10. A method to reduce the concentration of flavor compounds in a flour comprising:
combining the flour with a liquid to form a mixture having about 35 wt. % to about 55 wt. % flour;
seeding the mixture with at least one microorganism to form a seeded mixture, wherein the microorganism is not heterofermentative;
fermenting the seeded mixture at a temperature ranging between about 65° F. to about 110° F. for about 2.5 hours to about 17 hours to form a fermented material having a reduced concentration of hexanal ranging from about 0 ng/g to about 500 ng/g.

11. The method of claim 10, wherein the flour is formed from a grain, a pulse, a seed, or a combination thereof.

12. The method of claim 10, wherein the mixture includes between about 0.001 wt. % to about 10 wt. % added sugar.

13. The method of claim 10, wherein the at least one microorganism is selected from the group consisting of Lactobacillus Lactis, Streptococcus thermophiles, Lactobacillus delbrueckii, Lactobacillus acidophilus, Lactobacillus paracasei, Lactobacillus casei, Bifidobacterium animalis, Lactobacillus rhamnosus, Lactococcus lactis ssp. lactis, Lactococcus lactis ssp., Lueconostoc mesenteroids, Lactococcus lactis ssp. lactis, Lactobacillus sakei, Lactobacillus planetarium, and Kluyveromyces marxianus.

14. The method of claim 10, wherein the flour includes pre-gelled starch prior to combining with a liquid to form a mixture.

15. The method of claim 10, wherein the flour is extruded prior to combining with a liquid to form a mixture.

16. The method of claim 10 further comprising drying the fermented material to produce a fermented flour.

17. A food product formed from a dough comprising i) a fermented flour containing less than about 500 ng/g of hexanal, less than about 10 ng/g of pentanal, and less than 0.5 ng/g of decanal; and ii) a non-fermented flour.

18. The food product of claim 17, wherein the fermented flour further includes less than about 40 ng/g of heptanal, less than about 30 ng/g of nonanal, between about 10 ng/g to about 100 ng/g of benzaldehyde, less than about 25 ng/g of 3-methylbutanal, between about 1 ng/g and about 3 ng/g of 2,3-dimethyl-5-ethylpyrazine, and less than about 10 ng/g of methylpyrazine.

19. The food product of claim 17, wherein the dough includes a weight ratio of the fermented flour to the non-fermented flour of about 1:1, about 2:1, about 3:1, about 4:1, about 5:1, about 6:1, about 7:1, or about 8:1.

20. The food product of claim 19, wherein the fermented flour is produced using a chickpea flour.
